(19) United States
(12) Patent Application Publication
(10) Pub. No.: US 2021/0244235 A1
(43) Pub. Date: Aug. 12, 2021

(54) HEAT-DISTRIBUTING AND COAL-CONTAINING APPARATUS

(71) Applicant: Nelson Shen, Dongguan City (CN)

(72) Inventor: Nelson Shen, Dongguan City (CN)

(21) Appl. No.: 16/787,003

(22) Filed: Feb. 10, 2020

(51) Int. Cl. A47J 37/07

(52) U.S. Cl. CPC A47J 37/0786; F24B 1/193; A47J 37/0704

(57) ABSTRACT

A heat-distributing and coal-containing apparatus is useable in a barbecue grill based on combustion of gas or in a barbecue grill based on burning of coal as a coal tray. The heat-distributing and coal-containing apparatus includes a bent top and two trays. The trays extend from two opposite portions of the bent top. Each of the trays includes slots extending parallel to one another.

### BACKGROUND OF INVENTION

### 1. Field of Invention

The present invention relates to a barbecue grill and, more particularly, to a heat-distributing and coal-containing apparatus for use in a barbecue grill.

### 2. Related Prior Art

A barbecue grill is often used to heat and hence cook food. A barbecue grill is operated by burning coal or gas.

Briefly speaking, a barbecue grill based on combustion of coal includes a bowl for receiving a coal tray and a grid. In operation, the coal tray is located in a lower portion of the bowl and used to contain coal. The grill is located above the coal tray after the coal is ignited. Food is cooked on the grid.

A barbecue grill based on combustion of gas includes a bowl for receiving a burner, a heating plate and a grid. The burner is located in a lower portion of the bowl. The heating plate is located between the burner and the grid. In operation, gas is combusted at the burner to heat the heating plate. The heating plate heat food located on the grid.

However, the heating plate cannot be used in the barbecue grill based on combustion of coal. The coal tray cannot be used in the barbecue grill based on combustion of gas. However, this forces a manufacturer to make two flat elements and inevitably increases the costs of the barbecue grills.

The present invention is therefore intended to obviate or at least alleviate the problems encountered in prior art.

### SUMMARY OF INVENTION

It is the primary objective of the present invention to provide a heat-distributing and coal-containing apparatus for use as a heating plate in a barbecue grill based on burning of gas or a coal tray in a barbecue grill based on combustion of coal.

To achieve the foregoing objective, the heat-distributing and coal-containing apparatus includes a bent top and two trays. The trays extend from two opposite portions of the bent top. Each of the trays includes slots extending parallel to one another.

In another aspect, the heat-distributing and coal-containing apparatus further includes two canopies extending from two opposite ends of the bent top beyond the trays.

In another aspect, the bent top includes a ridge and two slant portions each of which extends to a corresponding one of the trays from the ridge.

In another aspect, the slant portions extend at an angle of 120°±15° relative to each other.

In another aspect, each of the trays includes an internal portion extending from the corresponding slant portion, a lower portion extending from the internal portion, and an external portion extending from the lower portion, thereby providing a space.

In another aspect, the internal portion of each of the trays extends at an angle of 150°±15° relative to the corresponding slant portion, thereby providing a bent portion between the internal portion of each of the trays and the corresponding slant portion.

In another aspect, each of the trays includes a bent rim extending from the external portion.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a heat-distributing and coal-containing apparatus for use as a heating plate or a coal tray in accordance with the preferred embodiment of the present invention;

FIG. 2 is a left view of the flat element shown in FIG. 1;

FIG. 3 is a bent top view of the flat element shown in FIG. 1; and

FIG. 4 is a front view of the flat element shown in FIG. 1.

### DETAILED DESCRIPTION OF PREFERRED EMBODIMENT

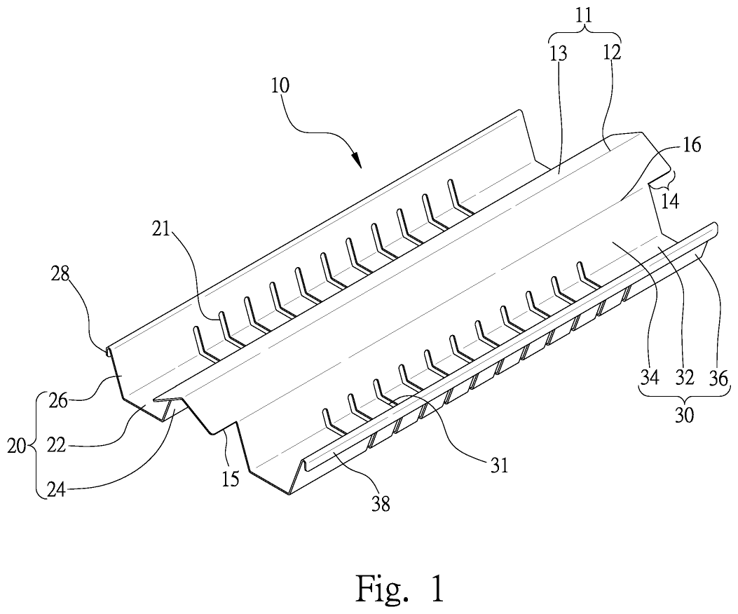

Referring to FIG. 1, a heat-distributing and coal-containing apparatus 10 can be used as coal tray in accordance with the preferred embodiment of the present invention. To this end, the heat-distributing and coal-containing apparatus 10 includes a bent top 11 formed between a first tray 20 and a second tray 30.

The bent top 11 includes a ridge 12 formed between two slant portions 13. One of the slat portions 13 extends to the first tray 20 from the ridge 12. The remaining one of the slat portions 13 extends to the second tray 30 from the ridge 12. Two canopies 14 extend from two opposite ends of the bent top 11. Each of the canopies 14 includes two lower edges 15.

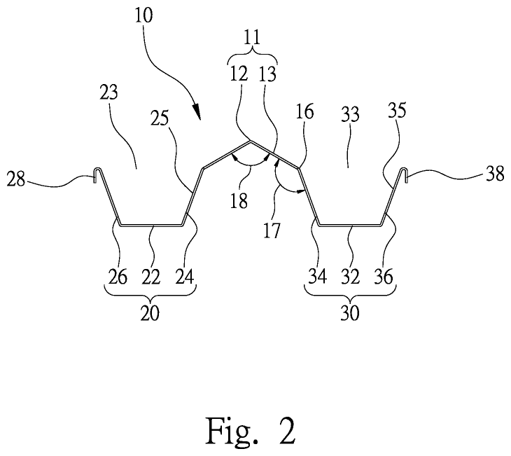

Referring to FIG. 2, the bent top 11 is an inverted V-shaped portion. There is an angle 18 of 120°±15° between the slant portions 13.

The first tray 20 includes a lower portion 22, an internal portion 24, an external portion 26 and a bent rim 28. The lower portion 22 is formed between the internal portion 24 and the external portion 26. The internal portion 24 extends from the corresponding slant portion 13. There is an angle 17 of 150°±15° between the internal portion 24 and the corresponding slant portion 13, thereby forming a bent portion 16 between the internal portion 24 and the corresponding slant portion 13. Together, the lower portion 22, the internal portion 24 and the external portion 26 provide a space 25. The space 25 includes an opening 23 at an upper portion. The width of the opening 23 is larger than the width of the lower portion 22. The bent rim 28 extends from the external portion 26. The bent rim 28 enhances the strength of the external portion 26.

Similarly, the second tray 30 includes a lower portion 32, an internal portion 34, an external portion 36 and a bent rim 38. The lower portion 32 is formed between the internal portion 34 and the external portion 36. The internal portion 34 extends from the corresponding slant portion 13. There is an angle 17 of 150°±15° between the internal portion 34 and the corresponding slant portion 13, thereby forming a bent portion 16 between the internal portion 34 and the corresponding slant portion 13. Together, the lower portion 32, the internal portion 34 and the external portion 36 provide a space 35. The space 35 includes an opening 33 at an upper portion. The width of the opening 33 is larger than the width of the lower portion 32. The bent rim 38 extends from the external portion 36. The bent rim 38 enhances the strength of the external portion 36.

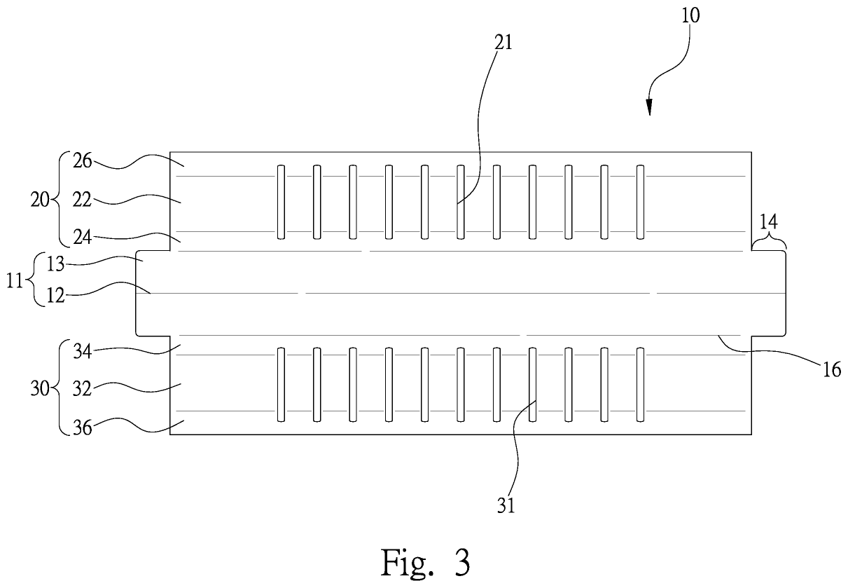

Referring to FIGS. 1 and 3, the heat-distributing and coal-containing apparatus 10 includes slots 21 in a lower portion of the first tray 20 and slots 31 in a lower portion of the second tray 30. Each of the slots 21 extends to the external portion 26 from the internal portion 24 via the lower portion 22. Each of the slots 31 extends to the external portion 36 from the internal portion 34 via the lower portion 32.

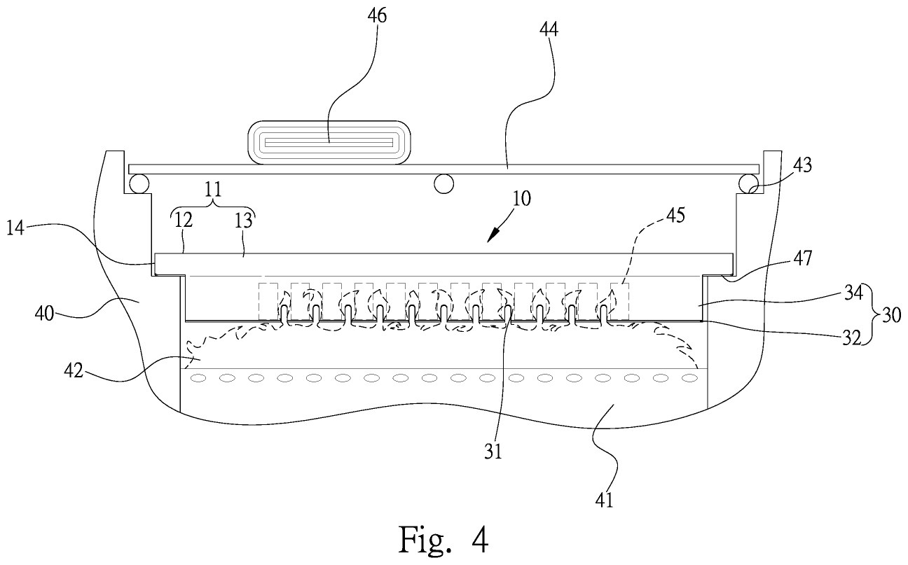

Referring to FIG. 4, a barbecue grill 40 is equipped with a burner 41. The barbecue grill 40 includes two upper shoulders 43 and two lower shoulders 47 on an internal side.

Each of the canopies 14 is supported on a corresponding one of the lower shoulders 47, thereby keeping the heat-distributing and coal-containing apparatus 10 above the burner 41. A grid 44 is supported on the upper shoulders 43. Thus, the grid 44 is located above the heat-distributing and coal-containing apparatus 10. Food 46 is supported on the grid 44.

In cooking, the burner 41 is ignited to burn gas to produce flames 42. The flames 42 enter the space 35 via the slots 31, thereby heating the heat-distributing and coal-containing apparatus 10. Then, the heat-distributing and coal-containing apparatus 10 heats and cooks the food 46.

As shown in phantom lines, a coal 45 is located on the lower portion 32. The flames 42 ignite the coal 45. Then, the burner 41 is turned off, leaving the burning coal 45 to heat and cook the food 46.

As discussed above, the heat-distributing and coal-containing apparatus 10 can be used as a coal tray because the second tray 30 receives the coal 45. The heat-distributing and coal-containing apparatus 10 can be used in the barbecue 40 or a barbecue grill based on combustion of coal only.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A heat-distributing and coal-containing apparatus comprising:
a bent top; and
two trays extending from two opposite portions of the bent top, wherein each of the trays comprises slots extending parallel to one another.

2. The heat-distributing and coal-containing apparatus in accordance with claim 1, further comprising two canopies extending from two opposite ends of the bent top beyond the trays.

3. The heat-distributing and coal-containing apparatus in accordance with claim 1, wherein the bent top comprises a ridge and two slant portions each of which extends to a corresponding one of the trays from the ridge.

4. The heat-distributing and coal-containing apparatus in accordance with claim 3, wherein the slant portions extend at an angle of 120°±15° relative to each other.

5. The heat-distributing and coal-containing apparatus in accordance with claim 3, wherein each of the trays comprises an internal portion extending from the corresponding slant portion, a lower portion extending from the internal portion, and an external portion extending from the lower portion, thereby providing a space.

6. The heat-distributing and coal-containing apparatus in accordance with claim 5, wherein the internal portion of each of the trays extends at an angle of 150°±15° relative to the corresponding slant portion, thereby providing a bent portion between the internal portion of each of the trays and the corresponding slant portion.

7. The heat-distributing and coal-containing apparatus in accordance with claim 5, wherein each of the trays comprises a bent rim extending from the external portion.
